(19) United States
(12) Patent Application Publication
(10) Pub. No.: US 2012/0199233 A1
(43) Pub. Date: Aug. 9, 2012

(54) REPAIR APPARATUS AND METHOD

(75) Inventors: Justin Mizell, Sarasota, FL (US); Dan Osborne, Gulfport, FL (US); Jerry Mixon, Sarasota, FL (US)

(73) Assignee: Video Inspections, Inc. d/b/a Sleuth Plumbing Technologies, Sarasota, FL (US)

(21) Appl. No.: 13/022,657

(22) Filed: Feb. 8, 2011

(51) Int. Cl. F16L 55/162

(52) U.S. Cl. 138/98

(57) ABSTRACT

A repair device may include a cured-in-place liner having a modification to prevent adhesion of the liner adjacent to an opening in a pipe during the curing process and where a fire activated device has previously been installed/located. The liner may also soften and give way under specific time/temperature exposure that permits an existing fire-stop device to function properly and as designed in a fire event while preventing that device from deploying prematurely and/or by failure of the existing strap, fitting and/or other design deficiency.

### FIELD OF THE INVENTION

A pipe repair and restoration apparatus is disclosed that may permit continued use of an existing thermally activated pipe shut-off device.

### BACKGROUND OF THE INVENTION

Thermally activated pipe shut-off devices may typically include a ball or plug that is positioned in a Y- or T-Type fitting for a pipe. The ball or plug is retained in the branch portion of the fitting by, for example, a band of low-fusing metal. In a fire, heat may melt or otherwise distort the band and release the ball or plug. The ball or plug may then descend into a narrower diameter region of the pipe—sealing the pipe. Thermally activated devices are taught, for example, by U.S. Pat. No. 1,106,427 to Taylor, No. 1,510,810 to Williams, No. 2,128,292 to Finn, No. 4,583,565 to Cornwall and No. 5,127,425 to Cornwall.

The band (or other apparatus) that retains the ball or plug in position in many shut-off has been found to degrade and fail over time. As a result, the ball or plug may be released prematurely (absent a fire), sealing the pipe. Conventional repairs and/or modifications to existing thermally activated pipe shut-off devices to address or prevent this issue of premature failure may require invasive and/or destructive actions to walls and property to remove or modify faulty and/or worn out parts. It is difficult, however, to replace or modify shut-off devices in existing homes, condominium, hotels and office buildings because they are behind walls and connected to the existing pipes and plumbing systems. Removing or repairing such devices can require cutting and removal of a large section of drywall or concrete to gain access to the part that is in need of repair and/or replacement. The difficulties of repairing such a device in a home, condominium, hotel or office are also multiplied when the devices are behind walls covered with custom paint and/or expensive wall coverings that may be impossible to restore to their original state without great expense and/or effort. Many shut-off devices also cannot readily be identified behind walls, or are not easily located, making the cost of access and repair prohibitive in most instances.

### SUMMARY OF THE INVENTION

A repair apparatus is disclosed that may be internally positioned in a pipe by an installer of cured-in-place pipe lining materials to block and/or prevent the premature activation of existing fire-stop devices. As a result, the need for external access of the faulty or worn out part is eliminated.

More specifically, a pipe repair and restoration apparatus may include a liner that may be inserted into a pipe and positioned proximate a lateral opening of a Y-Type or T-Type fitting that includes a thermally activated shut-off device. The liner may be constructed of known cure-in-place materials, such as a felt impregnated with resin (or another sufficiently porous and strong material such as fiberglass mesh) that hardens in place through a chemical reaction of the applied resins to form a solid barrier on the interior surface of the pipe surface. In addition, two to three inches of one end of the liner may be treated with a non-adheringly layer (such as a vinyl coating or tape) to prevent the treated area from adhering to the pipe wall in the immediate vicinity of the lateral opening of the fitting.

In operation, the liner is inserted in the pipe in an un-cured state and positioned so that the treated end covers at least a portion of the lateral opening of the Y- or T-Type fitting. The liner is then cured-in-place such that it becomes a rigid form. In this rigid, cured state, the liner may function to block a ball or plug of a thermally activated shut-off device that is prematurely released. In a fire, however, heat from the fire functions to warms the resin in the treated area of the liner to at or near the melting point. This softens that liner in the treated area, making it pliable, and allows the ball or plug of the shut-off device to move the liner aside and descend into the pipe.

### BRIEF DESCRIPTION OF THE DRAWINGS

Reference will now be made to the attached drawing wherein like reference numerals refer to like parts throughout and wherein:

FIG. 1 is a planar side cutaway view of an pipe having a Y-type fitting, a thermally activated pipe shut-off device positioned in the branch of the fitting, and an embodiment of a liner constructed in accordance with the present invention positioned in the fitting;

FIG. 2 is a planar side cutaway view of the pipe, fitting, shut-off device, and liner of FIG. 1, in which the shut-off device has prematurely failed, releasing the ball of the device, which is then retained in the branch portion of the fitting by the liner;

FIG. 3 is a planar side cutaway view of the pipe, fitting, shut-off device, and liner of FIG. 1, in which (like FIG. 2) the shut-off device has prematurely failed, and showing heat from a source (e.g., fire) ascending the pipe; and

FIG. 4 is a planar side cutaway view of the pipe, fitting, shut-off device, and liner of FIG. 1, in which the heat from a source (e.g., fire) has softened the liner in the treated area, making it pliable, and allowed the ball to move the treated area of the liner aside and descend into the pipe.

### DETAILED DESCRIPTION OF THE PREFERRED EMBODIMENTS

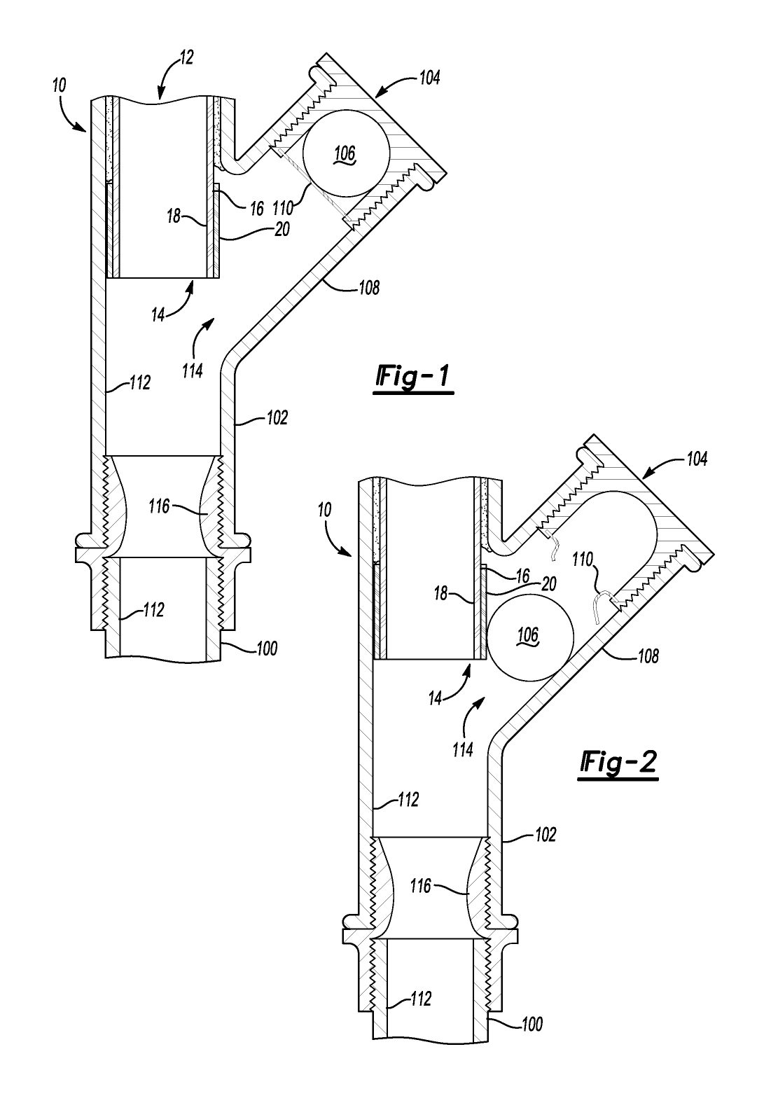

Referring now to FIGS. 1-4, a pipe repair and restoration apparatus 10 may include a liner 12 that may be installed within a pipe 100. The pipe 100 may have a Y- or T-Type fitting 102 that includes a thermally activated shut-off device 104 with a closure apparatus in the form of a ball or plug 106 (or the like) positioned in the branched portion 108 of the fitting 102. The ball or plug 106 for the device 102 may be retained in the branched portion 108 of the fitting 102 by a strap 110 or another article constructed of a low-fusing material.

Still referring to FIGS. 1-4, the liner 12 may be a tubular liner constructed of known cured-in-place materials, such as a felt impregnated with resin (or any other sufficiently porous and strong material such as fiberglass mesh and the like), that may harden in place through a chemical reaction of the applied resins to form a solid barrier on an interior surface 112 of the pipe 100 or fitting 102. In addition, between one-half and five inches (or more preferably between two to three inches) of one end 14 of the exterior surface 16 (or optionally the exterior 16 and interior 18 surfaces) of the liner 12 may be treated with a non-adhering or adhering prevention layer 20 (such as a vinyl coating or a vinyl tape). As will be described further infra, the layer 20 may function to prevent the treated area of the liner 12 from adhering to the interior surface 112 of the pipe 100. It will, however, be appreciated that other materials may also be used to prevent adhesion of a portion of one end of the liner 12 to interior wall 112 of the pipe 100.

Still referring to FIGS. 1-4, the liner 12 may be inserted into the pipe 100 in an uncured state and positioned so that at least a portion of the treated area of the liner 12 covers a lateral opening 114 of a branched portion 108 of the Y- or T-Type fitting 102 of the pipe 100. More specifically, the liner 12 may be positioned so that at least a portion of the treated end 14 at least partially blocks the lateral opening 114 of the fitting 102 when the liner 12 is installed. Once properly positioned, the liner 12 will then be cured-in-place. It will be appreciated, however, that while a majority of the liner 12 will thus adhere to the interior surface 112 of the pipe 100 during the curing process, the treated area of the liner 12 may function to prevent that portion of the liner 12 from adhering to the pipe wall 112. As a result, the treated area of the liner (i.e., at least a portion of which may cover the lateral opening 114) may not be adhered to the pipe wall 112.

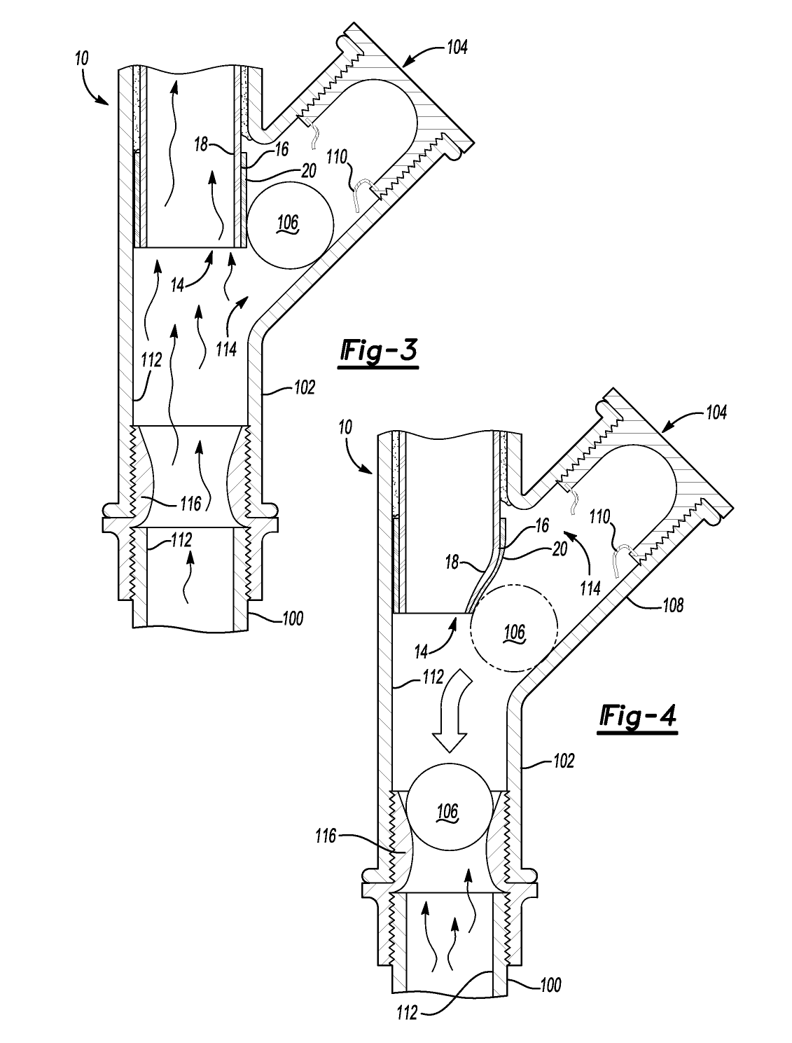

Still referring to FIGS. 1-4, and as best shown in FIGS. 2-3, a cured-in-place liner 12 having a treated end as described supra is shown positioned in a pipe 100 so that the treated end at least partially covers the lateral opening 114 of a Y- or T-Type fitting 102 that includes a thermally activated shut-off device 104. The strap 110 (which may be plastic) of the device 104 has prematurely failed by breaking or giving way and released the ball or plug 106 from the device 104. However, the rigid cured-in-place liner 12 may function to bar the ball or plug 106 from descending down the pipe 100 under normal conditions (e.g., non-fire) even though the strap 110 supporting the ball or plug 106 has failed.

Still referring to FIGS. 1-4, and as best shown in FIGS. 3-4, a cured-in-place liner 12 having a treated end 14 as described supra is shown positioned in a pipe 100 so that the treated end at least partially covers the lateral opening 114 of a Y- or T-Type fitting 102 that includes a thermally activated shut-off device 104. The strap 110 of the device 104 has prematurely failed by breaking or giving way and released the ball or plug 106 from the device 104. However, as shown in FIG. 3, in a fire heat will function to increase temperature of the liner 12. This increase in temperature also consequently increases the temperature of the resins in the liner 12 to at or near their melting point. As a result, the liner 12 may soften at the treated non-adhering end 14 of the liner 12. Indeed, it will be appreciated that liner 12 may be constructed with a resin(s) having a melting point at or near the melting point of the strap 110 so that the ball or plug 106 of the thermally activated shut-off device 104 may function to push passed the liner 12 at or near the same time the strap 110 of the device 104 would have originally released in the ball or plug 106.

Referring now to FIG. 4, once the liner 12 is softened, the weight of the ball or plug 106 may fold and/or bend the non-adhering end 14 of the liner inward and allow the ball or plug 106 to pass. The ball or plug 106 may then continue down the pipe 100 to a constriction point or member 116 to seal the pipe 100.

Accordingly, it will be appreciated that the liner 12 may be a repair device constructed of a cured-in-place lining material that has been modified to not adhere to a pipe immediately adjacent to the opening 114 of the fitting 102, and to also cover a portion of the opening 114 sufficient to block a fire-stop device 104, 106 from prematurely deploying unless heated to a sufficient temperature by fire or exposure, as during a fire event specified heat/time parameters which then allow the device 104, 106 to deploy correctly under the intended fire event conditions.

Having thus described one embodiment of the apparatus 10, various other embodiments will become apparent to those of skill in the art that do not depart from the scope of the claims.

1. A method for repairing a pipe comprising:
providing a pipe having a branched portion that opens into the pipe, with a thermally activated pipe shut-off device being positioned in the branched portion, and the shut-off device including a closure apparatus;
inserting a cure-in-place liner into the pipe, one end of the liner including a non-adhering layer, the non-adhering layer operating to prevent adhesion of the one end of the liner to an interior surface of the pipe when the liner is adhered to the interior surface of the pipe;
positioning the liner in the pipe so that at least a portion of the one end of the liner having the non-adhering layer at least partially covers the opening of the branched portion into the pipe; and
adhering the liner to the interior surface of the pipe.

2. The method of claim 1, wherein the branched portion comprises a fitting.

3. The method of claim 2, wherein the fitting comprises a t-type fitting.

4. The method of claim 2, wherein the fitting comprises a y-type fitting.

5. The method of claim 1, wherein the closure apparatus comprises a ball.

6. The method of claim 1, wherein the closure apparatus comprises a plug.

7. The method of claim 1, comprising a restriction member positioned in the pipe below the branched portion.

8. The method of claim 1, wherein the non-adhering layer comprises a vinyl coating.

9. The method of claim 1, wherein the non-adhering layer comprises a vinyl tape.

10. A repair apparatus comprising:
a tubular liner having a pair of open ends, an exterior surface and an interior surface, the liner including a fabric impregnated with a predetermined amount of a cure-in-place resin, the resin functioning to adhere the liner to an interior surface of a pipe into which the liner is positioned, and the exterior surface of one end of the liner including at non-adhering layer, the non-adhering layer functioning to prevent the adhesion of the the one end of the liner to a pipe into which the liner is positioned.

11. The apparatus of claim 10, wherein the non-adhering layer comprises a vinyl coating.

12. The apparatus of claim 10, wherein the non-adhering layer comprises a vinyl tape.

13. The apparatus of claim 10, wherein the interior surface of the liner comprises a non-adhereing layer.

14. The apparatus of claim 10, wherein the fabric is a felt.

15. The apparatus of claim 10, wherein the fabric is a fiberglass mesh.

16. The apparatus of claim 10, wherein the non-adhering layer extends between one-half inches and five inches up from the one end of the liner.
